(19) United States
(12) Patent Application Publication
(10) Pub. No.: US 2014/0298785 A1
(43) Pub. Date: Oct. 9, 2014

(54) INDUCTIVE DISPLACEMENT SENSOR

(71) Applicant: Continental Teves AG & Co. oHG, Frankfurt (DE)

(72) Inventors: Hilmar Müller, Heuchelheim (DE); Sören Lehmann, Frankfurt (DE); Martin Haverkamp, Frankfurt (DE)

(21) Appl. No.: 14/355,693

(22) PCT Filed: Nov. 2, 2012
(86) PCT No.: PCT/EP2012/071745

§ 371 Date: May 1, 2014

(30) Foreign Application Priority Data
Nov. 3, 2011 (DE) 10 2011 085 740.0

(51) Int. Cl. G01B 7/00; B60T 7/04; B60T 8/17; B60T 17/22

(52) U.S. Cl. CPC G01B 7/003; B60T 17/22; B60T 7/042; B60T 8/17
USPC 60/327; 60/534; 60/545; 324/207.15

(57) ABSTRACT

Inductive displacement sensor includes a coil and a target which is movable relative to the coil in a direction of movement, wherein an inductance of the coil is dependent on a position of the target relative to the coil, wherein the coil and the target at least partially overlap in the direction of movement.

### CROSS REFERENCE TO RELATED APPLICATION

This application is the U.S. National Phase Application of PCT International Application No. PCT/EP2012/071745, filed Nov. 2, 2012, which claims priority to German Patent Application No. 10 2011 085 740.0 filed Nov. 3, 2011, the contents of such applications being incorporated by reference herein.

### FIELD OF THE INVENTION

The present invention relates to an inductive displacement sensor as claimed in claim 1, a master cylinder as claimed in claim 5, a vehicle as claimed in claim 9 and a method as claimed in claim 10.

### BACKGROUND OF THE INVENTION

As is known from DE 40 04 065 A1, which is incorporated by reference, displacement sensors are used for measuring the position of a pressure piston in a master cylinder.

By way of example, eddy current sensors could be used for this purpose, as they are known by way of example from DE 196 31 438 A1, which is incorporated by reference.

### SUMMARY OF THE INVENTION

An aspect of the invention is to improve the displacement sensor in a master cylinder.

An aspect of the invention is based on the fact that in a conventional main cylinder the position of the pressure piston could be ascertained by way of the movement of a magnet with respect to one or multiple sensors. However, this magnet requires a great deal of space. In addition, the measuring principle depends upon the magnetic field inside the magnet and this magnetic field is not permanently constant since it weakens over a period of time. Although an electromagnet could overcome this disadvantage, said electromagnet could however render the construction technically complicated. In addition, the individual components for achieving the measuring principle are expensive.

It follows from this that the invention is based on the idea that an eddy current sensor can be constructed using cost-effective materials in a space-saving manner for the smallest space, since neither a magnet nor a corresponding magnet carrier is required. In addition, the physical measuring principle on which the eddy current sensor is based is not dependent upon the inherent physical characteristics on which the components are based but rather upon the supply of energy from an external energy source, such as for example from an oscillation circuit so that the eddy current sensor demonstrates fewer signs of aging and experiences fewer failures.

However, generally the distance between a coil and a corresponding object under test, referred to as a target, is measured using a conventional eddy current sensor. However, this distance measurement necessitates that the conventional eddy current sensor also requires a very large amount of space since the generation of a magnetic field alone by means of the coil itself requires a large amount of space.

In contrast thereto, the invention is based on the idea that it is not the distance between a coil and the target that is measured but rather the extent to which a target and a coil overlap when viewed in the direction of movement of the target. This idea is based on the knowledge that the target also changes the magnetic characteristics inside the coil and that this change can be measured with reference to the inductance of the coil.

An aspect of the invention therefore proposes an inductive displacement sensor comprising a coil and a target that moves relative to the coil in a direction of movement. An inductance of the coil is dependent upon a relative position of the target. In accordance with the invention, the coil and the target overlap at least in part in the direction of movement.

By virtue of the fact that the coil and the target overlap, it is not only possible to achieve the eddy current sensor in the smallest space but rather precise measurement results can also be achieved since the sensitivity of the sensor increases the closer the target is arranged to the coil.

In one development of the invention, the coil is a planar coil. The planar coil renders it possible to further reduce the size of the eddy current sensor. In this case, the target can be arranged parallel to the planar coil when viewed in the direction of movement of the planar coil, wherein the target can be displaced in the direction of movement by way of the planar coil for measuring purposes. In this manner, the planar coil and the target overlap on an overlap area, the size of which is dependent upon the position of the target with respect to the planar coil. The inductance of the planar coil is then dependent upon the size of this overlap area.

In an additional development of the invention, the planar coil is formed from conductor tracks of a circuit that is electrically connected to the planar coil for the purpose of ascertaining the inductance and for the purpose of outputting a signal that is dependent upon the inductance of the planar coil. In this manner, the planar coil can be attached directly to the circuit merely by virtue of forming the conductor tracks. In this manner, an extra coil for the angle sensor is omitted, which further reduces the size of the eddy current sensor. In addition, production costs and material costs can be reduced since it is neither necessary to provide an extra coil nor is it necessary to attach an extra coil to the circuit during an extra production step.

In a further development of the invention, insulation is arranged between the coil and the target. This insulation prevents the elements of the displacement sensor from short circuiting and consequently prevents undefined measuring conditions.

In a still further development of the invention, the target can be produced from a material that has electrically conductive and/or ferromagnetic characteristics. When using materials that have electrically conductive characteristics, such as for example aluminum or copper, the inductance of the coil changes as a result of eddy currents. When using materials that have ferromagnetic characteristics, such as for example soft iron, the inductance of the coil changes as a result of the change in its magnetic characteristics.

An aspect of the invention provides also a master cylinder for the purpose generating a hydraulic pressure for a hydraulic braking system based on the position of a brake pedal. The master cylinder comprises a housing having the hydraulic fluid, a pressure piston that moves in an axial manner in the housing by means of the brake pedal, and an inductive displacement sensor in accordance with the invention for the purpose of ascertaining the axial position of the piston in the housing.

In one development of the invention, the inductive displacement sensor is embodied on an outer face of the housing when viewed from the pressure piston. This represents a decisive advantage with respect to using a magnet to measure displacement since in this case it is no longer necessary to transmit through a wall of the housing the fields required for the measuring principle.

In an additional development of the invention, the pressure piston comprises a flange that protrudes over the housing and is provided for the purpose of moving the target. In this manner, the target can be moved directly by means of the pressure piston so that the position, the speed or the acceleration of the pressure piston are derived directly from the measurement results of the inductive displacement sensor.

In a preferred development, the master cylinder is a tandem master cylinder and therefore renders it possible to fulfill the legal standards for providing two brake circuits that can be switched independently of one another in a passenger motor vehicle.

An aspect of the invention also proposes a vehicle having a master cylinder in accordance with the invention.

An aspect of the invention provides a method for positioning a target that moves relative to a coil in a direction of movement in an inductive displacement sensor. The inductance of the coil is dependent upon the relative position of the coil with respect to the target. In accordance with the invention, the target is positioned in such a manner that the coil and the target overlap at least in part in the direction of movement.

Developments of the method can be method steps that in an expedient manner achieve the features of the proposed device or of the circuit in accordance with the subordinate claims.

### BRIEF DESCRIPTION OF THE DRAWINGS

The above described characteristics, features and advantages of this invention and the manner in which said characteristics, features and advantages are achieved can be more easily and more clearly understood in conjunction with the following description of the exemplary embodiments that are explained in detail with reference to the drawings, wherein:

FIG. 1 illustrates a tandem master cylinder having the inductive displacement sensor in accordance with the invention, and

FIG. 2 illustrates an exemplary circuit for evaluating the measurement results of the inductive displacement sensor in accordance with the invention.

### DETAILED DESCRIPTION OF THE PREFERRED EMBODIMENT

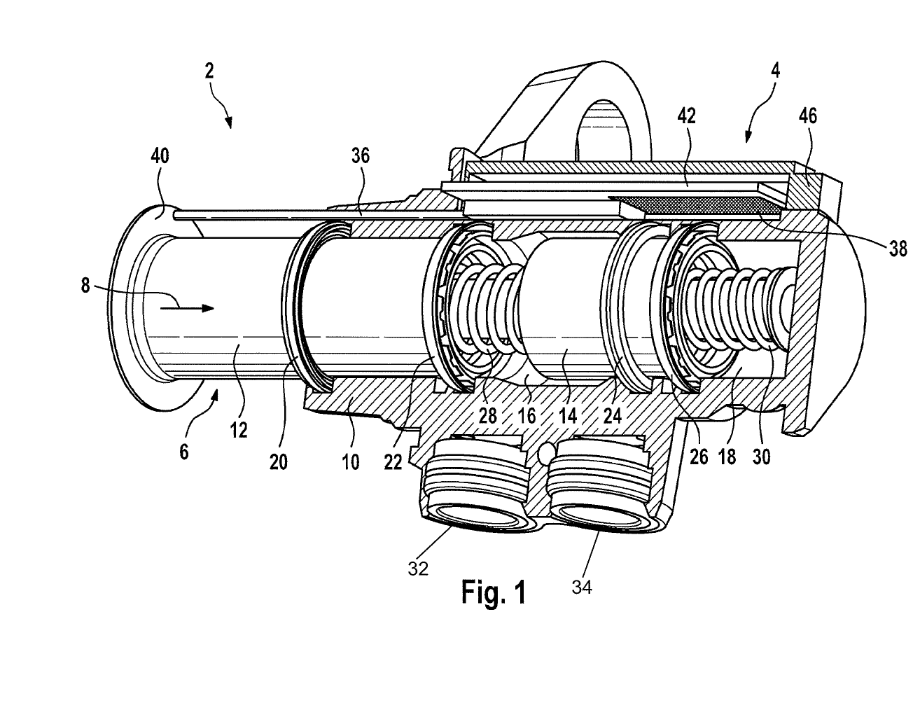

Reference is made to FIG. 1 that illustrates a tandem master cylinder 2 together with the inductive displacement sensor 4 in accordance with the invention. Furthermore, the tandem master cylinder 2 comprises a pressure piston 6 that is arranged in such a manner as to be able to move in a direction of movement 8 in a housing 10, wherein the movement of the pressure piston 6 can be controlled by means of a foot pedal (not illustrated). The pressure piston 6 itself is divided into a primary piston 12 and a secondary piston 14, wherein the primary piston 12 closes an inlet of the housing 10 and the secondary piston 14 divides the inner chamber of the housing 10 into a primary chamber 16 and a secondary chamber 18. A secondary collar 20 is arranged on the primary piston 12 in the region of the inlet of the housing 10 and said secondary collar insulates the inner chamber of the housing 10 from the environmental air. A primary collar 22 is arranged downstream of the secondary collar 20 when viewed looking into the inner chamber of the housing 10 and said primary collar seals a gap between the primary piston 12 and a wall of the housing 10. A pressure collar 24 on the secondary piston 14 insulates the pressure of the primary chamber 16 from the pressure of the secondary chamber 18. Moreover, a further primary collar 26 on the secondary piston 14 seals a gap between the secondary piston 14 and the wall of the housing 10. The primary piston 12 is supported against the secondary piston 14 by way of a first spring 28, whereas the secondary piston 14 is supported against a housing base by way of the second spring 30. It is possible by way of a first connection 32 and a second connect 34 to supply the primary chamber 16 and the secondary chamber 18 accordingly with hydraulic fluid (not illustrated).

Since the mode of operation of a tandem master cylinder is known to the person skilled in the art, a detailed representation of said tandem master cylinder is not provided.

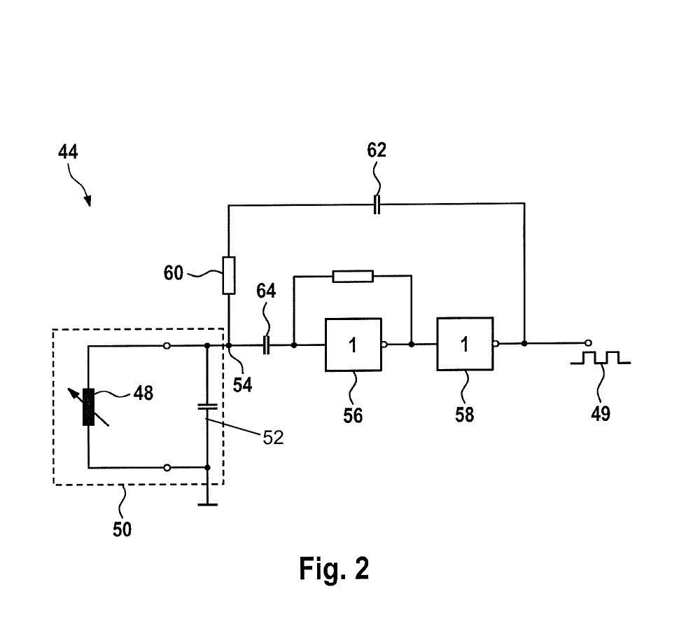

The inductive displacement sensor 4 in accordance with the invention comprises a target in the form of a slide 36 that can be displaced under a planar coil 38 when viewed in the plane of the figure. In order to displace the slide 36, the primary piston 12 comprises a flange 40 and the slide 36 is supported in a complimentary manner on said flange. The planar coil 38 is formed from multiple conductor tracks on a circuit board 42 that comprises a circuit 44, illustrated in FIG. 2, for the purpose of evaluating the inductance of the planar coil 38. A cover 46 can be placed over the circuit board 42 having the planar coil 38 for the purpose of providing protection by way of example against contamination.

Reference is made to FIG. 2 that illustrates an exemplary circuit diagram of the circuit 44.

In the present embodiment, the circuit 44 is embodied as an LC gate oscillator. On the basis of the inductance 48 of the planar coil 38, said LC gate oscillator generates by way of a parallel resonant circuit 50 an output signal 49 with a frequency that is dependent upon the inductance 48 by way of a parallel resonant circuit 50. As an alternative, the inductance could be determined using other oscillators, for example a Meissner oscillator, or by using other measuring principles, such as for example by ascertaining the impedance of the planar coil 38.

The parallel resonant circuit 50 in the illustrated circuit 44 is formed from the inductance 48 of the planar coil 38 and a capacitor 52. The amplification of the oscillation 54 that is generated by the parallel resonant circuit 50 is achieved by way of a first inverter 56 and a second inverter 58, said amplification being necessary for an oscillator. The necessary feedback to the parallel resonant circuit 50 is performed by way of a feedback resistor 60 and a feedback capacitor 62. The feedback resistor 60 determines the amplitude of the output signal 49 and thus the power consumption of the circuit 44. A filter capacitor 64 between the parallel resonant circuit 50 and the first inverter 56 filters signal components with low frequencies, such as for example an offset. Moreover, the first inverter 56 forms a subordinate feedback loop together with a further feedback resistor 66.

1. An inductive displacement sensor comprising a coil and a target that moves relative to the coil in a direction of movement, wherein an inductance of the coil is dependent upon a relative position of the target with respect to the coil, and wherein the coil and the target overlap at least in part in the direction of movement.

2. The inductive displacement sensor as claimed in claim 1, wherein the coil is a planar coil.

3. The inductive displacement sensor as claimed in claim 2, wherein the planar coil is formed from conductor tracks of a circuit that is electrically connected to the planar coil for the purpose of ascertaining the inductance and for the purpose of outputting a signal that is dependent upon the inductance of the planar coil.

4. The inductive displacement sensor as claimed in claim 1, further comprising insulation between the coil and the target.

5. A master cylinder for generating a hydraulic pressure for a hydraulic brake system based on the position of a brake pedal comprising a housing having the hydraulic fluid, a pressure piston that moves in an axial manner in the housing by the brake pedal, and an inductive displacement sensor as claimed in claim 1 for ascertaining the axial position of the pressure piston in the housing.

6. The master cylinder as claimed in claim 5, wherein the inductive displacement sensor is embodied on an outer face of the housing when viewed from the pressure piston.

7. The master cylinder as claimed in claim 5, wherein the pressure piston comprises a flange that protrudes beyond the housing and is provided for the purpose of moving the target.

8. The master cylinder as claimed in claim 5 to 7, wherein said master cylinder is a tandem master cylinder.

9. A vehicle comprising a master cylinder for generating a hydraulic pressure for a hydraulic brake system based on the position of a brake pedal comprising a housing having the hydraulic fluid, a pressure piston that moves in an axial manner in the housing by the brake pedal, and an inductive displacement sensor as claimed in claim 1 for ascertaining the axial position of the pressure piston in the housing.

10. A method for positioning a target that moves relative to a coil in a direction of movement in an inductive displacement sensor, wherein the inductance of the coil is dependent upon the relative position of the coil with respect to the target, of positioning the target in such a manner that the coil and the target overlap at least in part in the direction of movement.

11. The master cylinder as claimed in claim 6, wherein the pressure piston comprises a flange that protrudes beyond the housing and is provided for the purpose of moving the target.

12. The master cylinder as claimed in claim 6, wherein said master cylinder is a tandem master cylinder.

13. The master cylinder as claimed in claim 7, wherein said master cylinder is a tandem master cylinder.
